(19) United States
(12) Patent Application Publication
(10) Pub. No.: US 2006/0095550 A1
(43) Pub. Date: May 4, 2006

(54) Method and device for the automatic generation of program code documentation text and management information bases using the data of a database

(75) Inventors: Christoph Nemmaier, Munchen (DE); Helmut Sippel, Munchen (DE); Hubert Drexler, Taufkirchen (DE)

Correspondence Address: SCHIFF HARDIN, LLP;PATENT DEPARTMENT, 6600 SEARS TOWER, CHICAGO, IL, 60606-6473, US

(73) Assignee: Oce Printing Systems GmbH, Poing (DE)

(21) Appl. No.: 10/528,988

(22) PCT Filed: Jul. 9, 2003
(86) PCT No.: PCT/EP03/07438

§ 371 Date: Jul. 18, 2005

(30) Foreign Application Priority Data
Sep. 30, 2002 (DE) 102 45 527.9

(51) Int. Cl. G06F 15/173

(52) U.S. Cl. 709/223

(57) ABSTRACT

In a method for administration of at least one data object of a printer or copier, at least data of a data object are stored in a databank, and an identifier is associated with the data object. At least one first source code with a plurality of instructions is created in a programming language, the source code containing the identifier of the data object. From the first source code, a second source code is generated, the identifier of the data object being replaced by at least one part of the data stored in the databank regarding the data object.

### BACKGROUND

The preferred embodiment concerns a method for administration of at least one data object of an electrographic printer or copier as well as a device to administer at least one data object. In electrographic printers or copiers, in particular in electrographic high-capacity printers and high-capacity copiers with a print capacity of greater than 50 pages DIN A4 per minute, a plurality of data objects are necessary to control the printer or copier. The control units of such printers or copiers contain a program code that is executed by the respective control unit to control the printer or copier. Upon creation of the program code, the data objects, in particular the variables and constants, are added into this or into the source code from which the program code is generated. In known high-capacity printers, the individual control units and structural components are connected with one another via at least one printer-internal network. The management and administration of the control units and network components occurs, for example, with the aid of what is known as the Simple Network Management Protocol (SNMP).

What is known as a management information base (MIB) is preferably used for management and administration. A management information base contains data sets with whose help a network management system manages all objects to be managed, for example control units, peripheral devices, servers, hubs, bridges, routers and further components in the network. These data sets also contain data objects of the printer controller such as, for example, constants and variables.

Furthermore, documentations (such as, for example, service manuals and data sheets) that likewise contain data objects of the control units of the printer or copier have been created for known printers or copiers. A comparison of these data was very elaborate, whereby in particular all used variables and constants in the program modules as well as in the documentation respectively have to be checked and, if applicable, adapted given changes of program parts as well as given various delivery states of the same high-capacity printer type or copier type. The management information base likewise had to be adapted for network management. Errors thereby frequently occur, in particular in that individual data objects have not been correctly changed. The error-prone adjustments of setting parameters of the printer or copier resulting from this have led to faulty printer products as well as to a reduced operating life of individual printer components and consumable materials.

A print management system for administration of print protocols is known from the English-language translation of the summary of the patent application JP 2002259103 A. The print management system comprises a server that receives a protocol entry from a client given each executed print job as well as data from a databank (management information base) in predetermined time intervals, whereby the databank comprises information for network administration of a stored print job or a plurality of stored print jobs of a network printer. The server generates a list with protocol entries from the data of the databank and the protocol entries transferred by the client.

Furthermore, in the examination proceedings of the parallel German patent application 102 45 527.9 in front of the German Patent and Trademark Office, reference is made to the document “Stewart, B.: Definitions of Managed Objects for Parallel Printer-like Hardware Devices, April 1992, available on the Internet: URL:http://www.kblabs.com/lab/lib/rfcs/1300/rfc1318.txt.html”, researched on 15 Apr. 2003.

It is an object of the preferred embodiment to specify a method and a device for administration of data objects of an electrographic printer or copier, via which errors in the matching of the data objects are prevented in a simple manner.

In a method for administration of at least one data object of a printer or copier, at least data of a data object are stored in a databank, and an identifier is associated with the data object. At least one first source code with a plurality of instructions is created in a programming language, the source code containing the identifier of the data object. From the first source code, a second source code is generated, the identifier of the data object being replaced by at least one part of the data stored in the databank regarding the data object.

### BRIEF DESCRIPTION OF THE DRAWINGS

FIG. 1 is a block diagram to generate program modules, a text document and a management information base according to the present preferred embodiment; and

FIG. 2 is a representation of an output window of a program module to administer objects with the aid of a network management system.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

Via a method for administration of data objects of an electrographic printer or copier, it is achieved that the data of the data object are changed in the databank and that the changed data can be very simply adopted in the source code via the identifier. Thus the method of the preferred embodiment can, for example, be very simply executed by a data processing system that searches the first source code for the identifier of the data object and replaces the identifier with data of the data object that are stored in the databank, whereby the data processing system automatically generates the second source code. The second source code then contains exactly the data that are currently stored in the databank regarding the data object. It is thus ensured that, given a change of the data of the data object, a second source code is created in a simple manner in which the data of the first data object are current at each point of the second source code, corresponding to the data state of the databank. In particular, variables and constants as well as setting parameters can thereby be very simply administered and, if applicable, changed in the databank.

According to a second aspect of the preferred embodiment, the data objects stored in the databank can be used to generate further source codes. Thus, with the aid of the databank, a plurality of program codes for control units of the printer, the documentation and the general management of the printer, as well as a management information base, can be generated with exactly the same data objects, whereby errors and inconsistent statements about setting parameters, variables and constants are prevented.

A third aspect of the preferred embodiment concerns a device to administer data objects of an electrographic printer or copier. At least the data of one data object are stored in a first storage region. An identifier is associated with the data object. A first source code that comprises the identifier of the data object is stored in a second storage region. From the first source code, the device generates a second source code in which at least the identifier of the data object is replaced by the data of the data object.

Through this device, given a change of data objects, for example given a change of a variable or a constant, a source code no longer has to be searched through for this data object and every one of these data objects no longer has to be changed, if applicable, multiple times (as in the prior art); rather, only the data object in the databank is changed. A second source code that then contains the updated data of the data object is subsequently repeatedly generated from the same source code. Errors can thus be prevented. In particular when these data objects are contained in multiple source codes, discrepancies in the second source codes and between multiple source codes in which the same data objects are contained are prevented in a simple manner. Elaborate corrections of the source codes are no longer necessary.

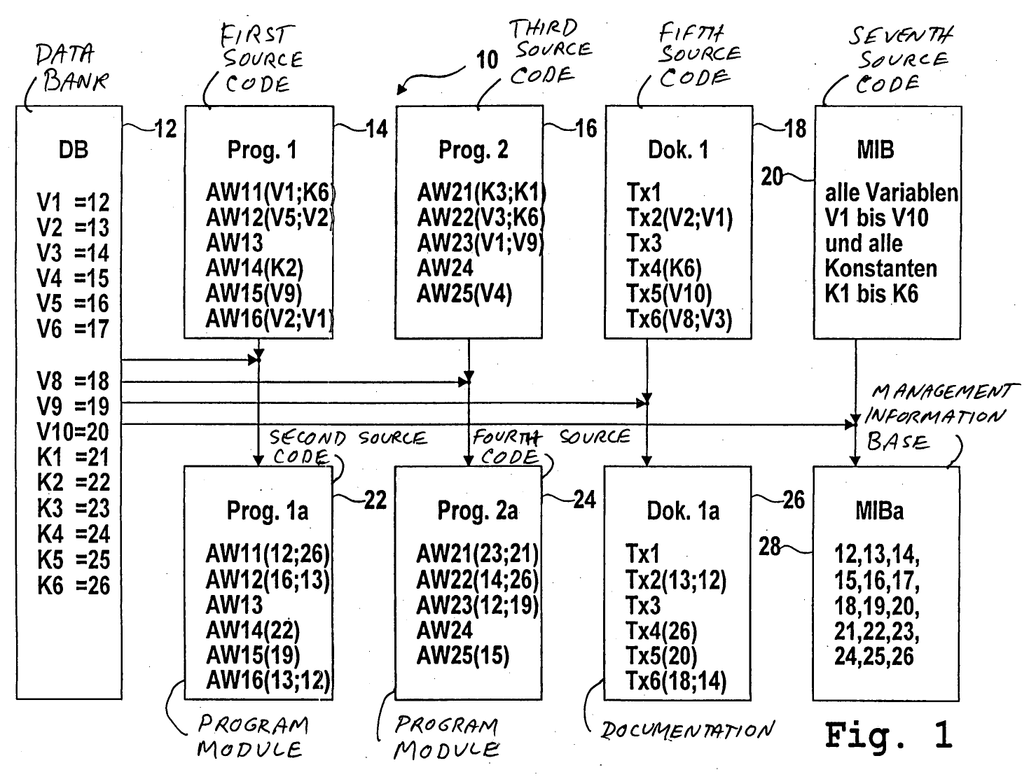

A block diagram of a system 10 for generation of program modules 22, 24 of a documentation 26 as well as a management information base 28 are shown in FIG. 1. Data objects are stored in a databank 12. The data objects comprise variables V1 through V10 and constants K1 through K6. For the data object, in particular the size, the type, the name, the position within a data object structure, the write and read accesses, the measuring unit, the limit values, the storage position of the data object in a non-volatile storage, the numerical value, the reset value, a value table and/or function calls for handling of the data object are contained in the databank. Respectively one numerical value is associated with both the variables V1 through V10 and the constants K1 through K6 in FIG. 1. The designation V1 through V10 as well as K1 through K6 serves as an identifier of the respective data object. However, other character strings can also be used as an identifier in other exemplary embodiments.

With the aid of a first programming environment, a source code 14 of a first program is created by a programmer for a first control unit with a plurality of instructions AW11 through AW16, for example in a programming language C⁺⁺, Java or Delphi. Instead of directly inserting the numerical values of the variable V1 and of the constant K6 into the instruction AW11 of the source code 14, the identifier of the variable V1 and of the constant K6 is inserted into the instruction AW11. Instead of the numerical values of the data objects V5 and V2, the instruction AW12 contains the identifiers V5 and V2. The instruction AW13 contains no data object. Instead of the numerical value of the data object K2, the instruction AW14 contains the identifier K2. The identifier V9 is inserted into the instruction AW15 instead of the numerical value of the data object V9. The instruction AW16 of the first source code 14 comprises the identifiers V2 and V1.

A second source code 22 is preferably created from the source code 14 of the first program with the aid of a data processing system. To generate the second source code 22 from the first source code 14, the identifiers of the variables V1 through V10 as well as the identifiers of the constants K1 through K6 are replaced by data, i.e. by the numerical values of the variables that are stored in the databank 12 for the data objects V1 through V10 and K1 through K6. The data processing system accesses the data stored in the databank 12 via a solid body interface. Such an interface is, for example, the ODBC interface.

Depending on the identifier of the data object, the identifier can be replaced by the complete data set of the data object or by only parts of the data set of the data object V1 through V10; K1 through K6.

In the exemplary embodiment according to FIG. 1, for simple comprehension each data set comprises only the numerical value and the identifier of the data object. In the second source code 22 this comprises instructions AW11 through AW16 that replace the numerical values 12 through 26 stored in the databank 12 for these identifiers V1 through V9, K2, K6, instead of replacing the identifiers V1 through V9, K2, K6. The instruction AW11 thus contains the numerical values 12 and 26, the instruction AW12 contains the numerical values 16 and 13, the instruction AW14 contains the numerical value 22, the instruction AW15 contains the numerical value 19, and the instruction AW16 contains the numerical values 13 and 12. The instruction AW13 was already associated with no identifier in the source code 14, such that this instruction AW13 has been associated with no numerical value from the databank 12 in the second source code 22.

A third source 16 of a second program contains instructions AW21 through AW25. The instruction AW21 contains the data objects K1 and K3, the instruction AW22 contains the data objects V3 and K6; the instruction AW23 contains the data objects V1 and V9, and the instruction AW25 contains the data object V4. In the same manner as has already been described for the first source code 14, a fourth source code 24 that contains the instructions AW21 through AW24 of the third source code 16 is generated from the third source code 16 of the second program, whereby the identifiers of the data objects V1 through V9, K1 through K6 have been replaced by the numerical values stored in the databank 12 for these identifiers V1 through V9, K1 through K6. The instruction AW21 thereby contains the numerical values 23 and 21, the instruction AW22 contains the numerical values 14 and 26, the instruction AW23 contains the numerical values 12 and 19, and the instruction AW25 contains the numerical value 15. In the third source code 16, the instruction AW24 already contains no identifier, such that the instruction AW24 in the fourth source code 24 contains no numerical value of a data object of the databank 12.

A fifth source code 18 is a text document created with the aid of a text processing program, which text document contains a service and maintenance manual as well as technical data of the printer. The text document contains text blocks Tx1 through Tx6, whereby the text block Tx2 contains identifiers V2 and V1, the text block Tx4 contains the identifier K6, the text block Tx5 contains the identifier V10 and the text block Tx6 contains the identifiers V8 and V3. The text blocks Tx1 and Tx3 contain no identifiers. A sixth source code 26 that contains the text blocks Tx1 through Tx6 is generated from the source code 18 of the text document in the same manner as for the source codes 14 and 16 of the programs 1 and 2, whereby the identifiers V1 through V10, K6 have been replaced by the numerical values stored in the databank 12 for these identifiers. The text block Tx2 of the second source code 26 thus contains the numerical values 13 and 12, the text block Tx4 contains the numerical value 26, the text block Tx5 contains the numerical value 20, and the text block Tx6 contains the numerical values 18 and 14.

A seventh source code 20 contains data of what is known as a management information base (MIB). The management information base contains data sets with whose help a network management system administers (for example with the help of the Simple Network Management Protocol (SNMP)) all objects to be administered, such as, for example, control units of the printer, servers integrated into the network of the printer, computers, hubs, bridges and routers. Such a management information base is thus always appropriately provided when the control units of the printer are connected with one another over a network, whereby a plurality of networks coupled with one another can be provided in the printer as well as outside of the printer. The management information base is thus an information base or a databank for administration of network elements, whereby the control units and software modules as well as data objects are recorded as network elements in the management information base. However, the network elements are also further data processing systems and control units connected with the printer. With the aid of such a management information base, each printer can also be monitored by a remotely arranged maintenance computer when this maintenance computer is connected with the printer, for example over the Internet. The management information base is a map of the most important variables or all variables and other data objects of the printer, whereby the data objects are arranged in the same tree structure as that with which the control units are organized in the printer in which they are stored or by which they are administered.

Further information, such as limit values, a physical unit, a specification text of the variables, the size of the variables as well as the type of the variables are contained in the management information base. This information can be represented with the aid of a suitable software that, for example, generates a graphical user interface on a display unit. The current numerical values of the data objects can be read out with the aid of such an interface, and new numerical values can be input that then are transferred to the respective controller and are stored as new numerical values of the variables or of the data object. The interface with which the management information base is displayed serves as what is known as an SNMP sub-agent that accesses the control units of the printer from an SNMP agent provided by a central administration computer. The variables stored and administered in a control unit can be further sub-divided into function blocks in order to be able to administer the variables with greater ease and more clarity.

Variable definitions in source codes of program modules, for example variable definitions for programming languages such as Delphi or C++, can also be automatically generated (with the aid of scripts) from the data stored in the databank 12, which data are associated with the individual variables. Such scripts can, for example, be generated with a scripting language, such as with the scripting language Pearl. Furthermore, items of information for position of the control unit in the network, with which information is associated the respective data object V1 through V10, K1 through K6, are stored in the databank, whereby the physical network structure of the control units or of the network elements can be simulated in the management information base. A simple and clear administration of variables and of the controllers is thus possible with the aid of the management information base. In order to be able to actually implement maintenance and setting tasks with justifiable expenditure, such a clear management information base is in particular necessary given a tree-like arrangement of the controllers.

Variables for other printer or copiers can also be contained in the databank 12, whereby the association with the respective printer (for example via a databank field) is then contained in the data set of the respective variable. For example, with the aid of data filters, the data objects V1 through V10, K1 through K6 that should be adopted into the management information base for the respective printer can then be simply determined for the management information base. An association of the data objects V1 through V10, K1 through K6 with the respective program modules 14, 16, 22, 24, can occur in the same manner with the aid of information that are contained in the data sets of the data objects in the databank 12.

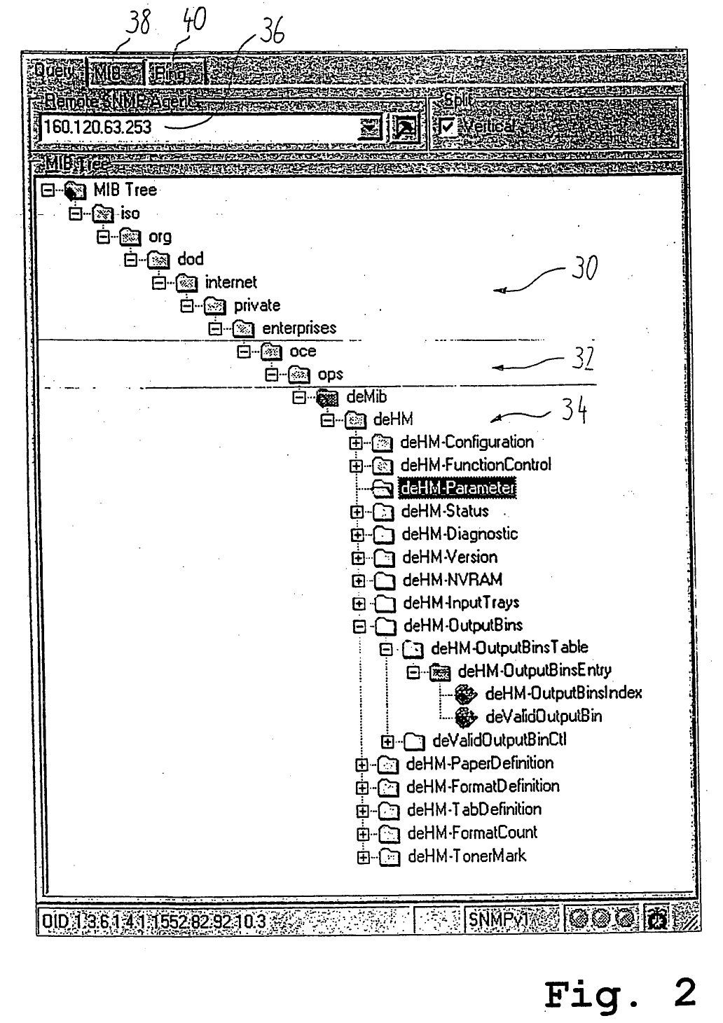

A graphical user interface for representation and administration of management information bases is shown in FIG. 2. In the representation of the management information base according to FIG. 2, the network elements and data objects are shown as directories and directory entries in the same tree-like hierarchical structure as that with which the network elements and data objects are arranged in the network of the printer. In region 34, the directory and file tree shown in FIG. 2 contains all control units as directories and contains the variables as entries in the directories of the control units.

A first central part 30 of the management information base is predetermined by international standardization of the management information base. A further sub-division in the region 32 is carried out by an internal organization of the firm Océ Printing Systems. A directory for a printer controller management information base with the designation deMib was generated in the sub-directory ops. All further sub-directories and entries in this printer controller management information base have been automatically generated from the information of the databank 12. Thus configuration data objects are contained in the sub-directory deHM configuration. Data for function control of the main module of the printer are contained in the directory deHM-Function Control. Current setting values are contained in the sub-directory deHM-Status. Data objects for maintenance and diagnosis of the printer are contained in the sub-directory deHM-Diagnostic. The version number of the management information base is contained in the directory deHM-Version. The variables that are stored in a battery-buffered RAM storage element are contained in the sub-directory deHM-NVRAM. The listed sub-directories contain data objects and/or further sub-directories in which are contained the data objects and/or information regarding the data objects.

Diverse data objects are stored in the directory deHM-OutputBins. The directory deHM-OutputBins contains the sub-directory deHM-OutputBinsTable, which in turn contains the directory deHM-OutputBinsEntry, in which the variables deHM-OutputBinsIndex and deValidOutputBin are stored. Respective properties for both of these data objects can be displayed, which properties are contained in the associated data set in the databank 12 from which the respective entry in the management information base has been generated. In the other cited directories (both in those further shown and those not further shown), a plurality of data objects are contained that contain the variables and constants as well as further data objects. Individual variables can thereby also contain value tables or refer to functions or procedures of program elements that are executed upon invocation of the variable or from which the current value of this variable is determined via execution of the procedure or of the function.

A network address of the printer is set in the field 36 of the user interface shown in FIG. 2, for which network address the association of the variables contained in the tree of the management information base is explicit. This network address is an IP address according to the Internet Protocol. The region 34 of the management information base is identical for all printers of the same structural type.

An interface in which the management information bases (that should be contained in the management information base directory tree shown in FIG. 2) can be selected is displayed (not shown) with the help of a register map that is activated with the aid of a rider 38. A graphical user interface of a program for a communication test with a network participant (for example with a printer connected with the network) is invoked with the rider 40.

Although a preferred exemplary embodiment is displayed and described in detail in the drawings and in the preceding specification, this should be viewed as purely exemplary and not as limiting the invention. It is noted that only the preferred exemplary embodiment is shown and specified, and all variations and modifications that presently and in the future lie within the protective scope of the invention should be protected.

1-13. (canceled)

14. A method for administration of at least one data object of a printer or copier, comprising the steps of:
storing at least data of a data object in a databank, and associating an identifier with the data object;
creating at least one first source code with a plurality of instructions in a programming language, said source code containing the identifier of the data object; and
from said first source code generating a second source code, the identifier of the data object being replaced by at least one part of the data stored in the databank regarding said data object.

15. A method according to claim 14 wherein the data object contains at least one of the elements selected from the group consisting of a variable and a constant.

16. A method according to claim 14 wherein a program code for execution in a control unit of the printer or copier is generated with aid of the second source code.

17. A method according to claim 14 wherein at least one of the elements selected from the group consisting of the second source code and a program module generated from the second source code comprises a machine program module.

18. A method according to claim 14 wherein the second source code comprises a text document.

19. A method according to claim 18 wherein the text document comprises at least one of the elements selected from the group consisting of an operating manual, a service manual, and a technical specification of the printer or copier.

20. A method according to claim 14 wherein the second source code comprises a management information base or, with aid of the second source code, a management information base is generated with whose help at least one of the elements selected from the group consisting of a control unit and a structural unit of the printer are administered.

21. A method according to claim 14 wherein the data stored in the databank are accessed via a standardized application interface.

22. A method according to claim 14 wherein at least the first source code comprises a script created in a scripting language, the second source code being generated from the data contained in the databank with aid of the script.

23. A method according to claim 14 wherein at least the first source code is created in a scripting language.

24. A method according to claim 14 wherein the data of the data object comprises at least one of the elements selected from the group consisting of size, type, name, position within a data object structure, write/read rights, unit, limit values, and function calls for handling of the data object.

25. A method according to claim 14 wherein the same identifier is associated with a plurality of data objects, and the identifier in the first source code is replaced by data of a plurality of data objects.

26. A device for administration of at least one data object of a printer or copier, comprising:
a first storage region in which at least data of one data object are stored, and wherein an identifier is associated with the data object;
a second storage region in which at least one first source code with a plurality of instructions is stored in a programming language, the source code containing the identifier of the data object; and
the device generates from the first source code a second source code in which the identifier of the data object is replaced by at least a part of the data stored regarding said data object.

27. A method for administration of at least one data object of a printer or copier, comprising the steps of:
storing at least data of a data object in a databank, and associating an identifier with the data object, the data object containing at least one of the elements selected from the group consisting of a variable and a constant;
creating at least one first source code with a plurality of instructions in a programming language, said source code containing the identifier of the data object;
from said first source code generating a second source code, the identifier of the data object being replaced by at least one part of the data stored in the databank regarding said data object; and
generating with aid of the second source code a program code for execution in a control unit of the printer or copier.
